(19) United States
(12) Patent Application Publication
(10) Pub. No.: US 2017/0331928 A1
(43) Pub. Date: Nov. 16, 2017

(54) MANAGING FRAGMENTATION CONFIGURATIONS

(71) Applicant: QUALCOMM Incorporated, San Diego, CA (US)

(72) Inventor: Alfred Asterjadhi, San Diego, CA (US)

(21) Appl. No.: 15/599,139

(22) Filed: May 18, 2017

Related U.S. Application Data
(63) Continuation of application No. 15/590,916, filed on May 9, 2017.
(60) Provisional application No. 62/336,480, filed on May 13, 2016.
(60) Provisional application No. 62/419,453, filed on Nov. 8, 2016.

(51) Int. Cl. H04L 29/06; H04L 12/805

(52) U.S. Cl. CPC H04L 69/166; H04L 47/36; H04L 69/163; H04L 69/161

(57) ABSTRACT

Methods, systems, and devices are described for wireless communications. A recipient device may receive a session initiation request from an originator device. The recipient device may support a first fragmentation configuration that supports inclusion of multiple data fragments per transmission data unit. The recipient device may determine to use a second fragmentation configuration in place of the first fragmentation configuration, where the second fragmentation configuration supports inclusion of fewer data fragments per transmission data unit than that supported by the first fragmentation configuration. The recipient device may then transmit a session initiation response indicating use of the second fragmentation configuration.

### CROSS REFERENCES

The present Application for Patent is a continuation of U.S. patent application Ser. No. 15/590,916 by Asterjadhi, entitled “Managing Fragmentation Configurations,” filed May 9, 2017, which claims priority to U.S. Provisional Patent Application No. 62/336,480 by Asterjadhi, entitled “Managing Fragmentation Configurations,” filed May 13, 2016, and to U.S. Provisional Patent Application No. 62/419,453 by Asterjadhi, entitled, “Managing Fragmentation Configurations,” filed Nov. 8, 2016, assigned to the assignee hereof.

### BACKGROUND

The following relates generally to wireless communication, and more specifically to techniques for managing data fragmentation configurations in a wireless local area network (WLAN).

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

A WLAN, such as a Wi-Fi (IEEE 802.11) network, includes one or more access points (APs). The AP simultaneously supports communications for multiple mobile devices or stations (STAs) over a shared radio frequency spectrum band. In some instances, a WLAN may support data fragmentation, where a transmitting AP or STA may break up a data transmission of a data packet into fragments, and transmit the fragments separately to a receiving AP or STA. An AP or STA may be statically configured to support a particular fragmentation configuration, and may reserve resources for the particular fragmentation configuration. The inflexibility of static fragmentation configuration, and the resulting static resource allocation, may reduce the efficiency of communications over a WLAN.

### SUMMARY

The present description discloses techniques for managing data fragmentation configurations in a wireless local area network (WLAN). According to the techniques, a recipient station (STA) or an originator STA may use a fragmentation configuration for a communication session. The communication session may support fewer data fragments per transmission data unit than the maximum fragment usage capability of the STA. In an example, a recipient STA receives a session initiation request from an originator STA. The recipient STA supports a first fragmentation configuration that may include multiple data fragments per transmission data unit. However, the recipient STA determines to use a second fragmentation configuration in place of the first fragmentation configuration. The second fragmentation configuration may include fewer data fragments per transmission data unit than that supported by the first fragmentation configuration. The recipient STA then transmits a session initiation response indicating use of the second fragmentation configuration.

In another example, an originator STA identifies a first fragmentation configuration and a second fragmentation configuration. The first fragmentation configuration may include multiple data fragments per transmission data unit, and the second fragmentation configuration may include fewer data fragments per transmission data unit than that supported by the first fragmentation configuration. The originator STA transmits a session initiation request requesting use of the second fragmentation configuration in place of the first fragmentation configuration for data transmissions. The originator STA then transmits data according to the second fragmentation configuration.

Thus, in an example, a method for wireless communication is described. The method includes, a recipient STA receiving a session initiation request from an originator STA, where the recipient STA supports a first fragmentation configuration that may include multiple data fragments per transmission data unit. The recipient STA determines a second fragmentation configuration, to use in place of the first fragmentation configuration, the second fragmentation configuration may include fewer data fragments per transmission data unit than that supported by the first fragmentation configuration. The recipient STA also transmits a session initiation response indicating use of the second fragmentation configuration.

In another example, a communications device for wireless communication is described. The communications device includes means for receiving, at a recipient STA, a session initiation request from an originator STA, where the recipient STA supports a first fragmentation configuration that supports inclusion of multiple data fragments per transmission data unit, means for determining to use a second fragmentation configuration in place of the first fragmentation configuration, the second fragmentation configuration supporting inclusion of fewer data fragments per transmission data unit than that supported by the first fragmentation configuration, and means for transmitting a session initiation response indicating use of the second fragmentation configuration.

In another example, another communications device for wireless communication is described. The communications device includes a receiver to receive, at a recipient STA, a session initiation request from an originator STA, where the recipient STA supports a first fragmentation configuration that may include multiple data fragments per transmission data unit. The communications device also includes a fragmentation configuration manager to determine to use a second fragmentation configuration in place of the first fragmentation configuration, the second fragmentation configuration may include fewer data fragments per transmission data unit than that supported by the first fragmentation configuration. The communications device also includes a transmitter to transmit a session initiation response indicating use of the second fragmentation configuration.

In another example, a non-transitory computer-readable medium storing code for wireless communication at a wireless station is described. The code includes instructions executable to cause a communication device to receive, at a recipient STA, a session initiation request from an originator STA, where the recipient STA supports a first fragmentation configuration that may include multiple data fragments per transmission data unit. The code also includes instructions executable to cause the communication device to determine to use a second fragmentation configuration in place of the first fragmentation configuration, the second fragmentation configuration may include fewer data fragments per transmission data unit than that supported by the first fragmentation configuration. The code also includes instructions executable to cause the communication device to transmit a session initiation response indicating use of the second fragmentation configuration.

In some examples of the method, communication devices, or non-transitory computer-readable medium described above, the first fragmentation configuration enables support for up to four fragments per transmission data unit, and the second fragmentation configuration enables support for up to one fragment per transmission data unit. In some examples of the method, communication devices, or non-transitory computer-readable medium described above, the first fragmentation configuration enables support for up to four fragments per transmission data unit, and the second fragmentation configuration enables support for one fragment per transmission data unit.

Some examples of the method, communication devices, or non-transitory computer-readable medium described above include processes, features, means, or instructions for indicating in the session initiation response that the recipient STA will not use the first fragmentation configuration. Indicating that the recipient STA will not use the first fragmentation configuration is based at least in part on the recipient STA not allocating resources to enable the first fragmentation configuration. Other examples include processes, features, means, or instructions for indicating in a capabilities field that the first fragmentation configuration is enabled at the recipient STA before receiving the session initiation request.

In some examples of the method, communication devices, or non-transitory computer-readable medium described above, the transmission data unit includes a medium access control layer protocol data unit (MPDU), and each data fragment is a fragment of a medium access control layer service data unit (MSDU). In other examples, the session initiation request includes an add block acknowledgement (ADDBA) request, and the session initiation response includes an ADDBA response.

In another example, a method for wireless communication is described. The method includes an originator STA identifying, a first fragmentation configuration and a second fragmentation configuration, the first fragmentation configuration may include multiple data fragments per transmission data unit, and the second fragmentation configuration may include fewer data fragments per transmission data unit than that supported by the first fragmentation configuration. The originator STA also transmits a session initiation request requesting use of the second fragmentation configuration in place of the first fragmentation configuration for data transmissions, and transmits data according to the second fragmentation configuration.

In another example, a communication device for wireless communication is described. The communication device includes means for identifying, at an originator STA, a first fragmentation configuration and a second fragmentation configuration, the first fragmentation configuration supporting inclusion of multiple data fragments per transmission data unit, and the second fragmentation configuration supporting inclusion of fewer data fragments per transmission data unit than that supported by the first fragmentation configuration, means for transmitting a session initiation request requesting use of the second fragmentation configuration in place of the first fragmentation configuration for data transmissions, and means for transmitting data according to the second fragmentation configuration.

In another example, another communication device for wireless communication is described. The communication device includes a fragmentation configuration manager, for an originator STA to identify a first fragmentation configuration and a second fragmentation configuration, the first fragmentation configuration may include of multiple data fragments per transmission data unit, and the second fragmentation configuration may include fewer data fragments per transmission data unit than that supported by the first fragmentation configuration. The communication device also includes a fragmentation message manager to transmit a session initiation request requesting use of the second fragmentation configuration in place of the first fragmentation configuration for data transmissions. The communication device also includes a transmitter to transmit data according to the second fragmentation configuration.

In another example, a non-transitory computer-readable medium storing code for wireless communication at a wireless station is described. The code includes instructions executable to cause a communication device to identify, at an originator STA a first fragmentation configuration and a second fragmentation configuration, the first fragmentation configuration supporting inclusion of multiple data fragments per transmission data unit, and the second fragmentation configuration supporting inclusion of fewer data fragments per transmission data unit than that supported by the first fragmentation configuration. The code also includes instructions executable to cause the communication device to transmit a session initiation request requesting use of the second fragmentation configuration in place of the first fragmentation configuration for data transmissions. The code also includes instructions executable to cause the communication device to transmit data according to the second fragmentation configuration.

In some examples of the method, communication devices, or non-transitory computer-readable medium described above, the first fragmentation configuration enables support for up to four fragments per transmission data unit, and the second fragmentation configuration enables support for up to one fragment per transmission data unit. In some examples of the method, communication devices, or non-transitory computer-readable medium described above, the first fragmentation configuration enables support for up to four fragments per transmission data unit, and the second fragmentation configuration enables support for one fragment per transmission data unit.

Some examples of the method, communication devices, or non-transitory computer-readable medium described above include processes, features, means, or instructions for receiving a session initiation response from a recipient STA indicating that the recipient STA will not use the first fragmentation configuration. In some examples, indicating that the recipient STA will not use the first fragmentation configuration is based at least in part on the recipient STA not allocating resources to enable the first fragmentation configuration.

In some examples of the method, communication devices, or non-transitory computer-readable medium described above, the session initiation request includes an ADDBA request; and the session initiation response includes an ADDBA response. In some examples, the transmission data unit includes a MPDU, and each data fragment is a fragment of a MSDU.

In another example, a method for wireless communication is described. The method includes a recipient STA receiving a session initiation request from an originator STA, where the recipient STA supports a first fragmentation configuration that may include up to one data fragment per transmission data unit. The recipient STA determining to use a second fragmentation configuration in place of the first fragmentation configuration, the second fragmentation configuration may include one data fragment per transmission data unit. The recipient STA also transmits a session initiation response indicating use of the second fragmentation configuration.

In another example, a communications device for wireless communication is described. The communications device includes means for receiving, at a recipient STA, a session initiation request from an originator STA, wherein the recipient STA supports a first fragmentation configuration that supports inclusion of up to one data fragment per transmission data unit, means for determining to use a second fragmentation configuration in place of the first fragmentation configuration, the second fragmentation configuration supporting inclusion of one data fragment per transmission data unit, and means for transmitting a session initiation response indicating use of the second fragmentation configuration.

In another example, another communications device for wireless communication is described. The communications device includes a receiver, for a recipient STA to receive a session initiation request from an originator STA, where the recipient STA supports a first fragmentation configuration that may include up to one data fragment per transmission data unit. The communications device also includes a fragmentation configuration manager to determine to use a second fragmentation configuration in place of the first fragmentation configuration, the second fragmentation configuration may include one data fragment per transmission data unit. The communications device also includes a transmitter to transmit a session initiation response indicating use of the second fragmentation configuration.

In another example, a non-transitory computer-readable medium storing code for wireless communication at a wireless station is described. The code includes instructions executable to cause a communication device to receive, at a recipient STA, a session initiation request from an originator STA, wherein the recipient STA supports a first fragmentation configuration that supports inclusion of up to one data fragment per transmission data unit. The code also includes instructions executable to cause the communication device to determine to use a second fragmentation configuration in place of the first fragmentation configuration, the second fragmentation configuration supporting inclusion of one data fragment per transmission data unit. The code also includes instructions executable to cause the communication device to transmit a session initiation response indicating use of the second fragmentation configuration.

In another example, a method for wireless communication is described. The method includes an originator STA identifying, a first fragmentation configuration and a second fragmentation configuration, the first fragmentation configuration may include up to one data fragment per transmission data unit, and the second fragmentation configuration may include one data fragment per transmission data unit, transmitting a session initiation request requesting use of the second fragmentation configuration in place of the first fragmentation configuration for data transmissions, and transmitting data according to the second fragmentation configuration.

In another example, a communication device for wireless communication is described. The communication device includes means for identifying, at an originator STA, a first fragmentation configuration and a second fragmentation configuration, the first fragmentation configuration supporting inclusion of up to one data fragment per transmission data unit, and the second fragmentation configuration supporting inclusion of one data fragment per transmission data unit, means for transmitting a session initiation request requesting use of the second fragmentation configuration in place of the first fragmentation configuration for data transmissions, and means for transmitting data according to the second fragmentation configuration.

In another example, another communication device for wireless communication is described. The communication device includes a fragmentation configuration manager for an originator STA to identify a first fragmentation configuration and a second fragmentation configuration, the first fragmentation configuration may support up to one data fragment per transmission data unit, and the second fragmentation configuration may support one data fragment per transmission data unit. The communication device also includes a fragmentation message manager to transmit a session initiation request requesting use of the second fragmentation configuration in place of the first fragmentation configuration for data transmissions. The communication device also includes a transmitter to transmit data according to the second fragmentation configuration.

In another example, a non-transitory computer-readable medium storing code for wireless communication at a wireless station is described. The code includes instructions executable to cause a communication device to identify, at an originator STA a first fragmentation configuration and a second fragmentation configuration, the first fragmentation configuration supporting inclusion of up to one data fragment per transmission data unit, and the second fragmentation configuration supporting inclusion of one data fragment per transmission data unit. The code also includes instructions executable to cause the communication device to transmit a session initiation request requesting use of the second fragmentation configuration in place of the first fragmentation configuration for data transmissions. The code also includes instructions executable to cause the communication device to transmit data according to the second fragmentation configuration.

Some examples of the methods, communications devices, or non-transitory computer-readable media described herein may include processes, features, means, or instructions for congestion based roaming in a WLAN. Further, scope of the applicability of the described systems, methods, communications devices, or computer-readable media will be apparent in the following detailed description, claims, and drawings. The detailed description and specific examples are given by way of illustration, since various changes and modifications within the scope of the description will become apparent to those skilled in the art.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label, irrespective of the second reference label.

FIG. 1 illustrates an example of a network, such as a wireless local area network (WLAN), that supports managing data fragmentation configurations in a WLAN in accordance with various aspects of the present disclosure;

FIG. 2 illustrates an example of a wireless communications subsystem that supports managing data fragmentation configurations in a WLAN in accordance with various aspects of the present disclosure;

FIG. 3 shows a process flow that illustrates examples of data fragmentation configuration management in a WLAN in accordance with various aspects of the present disclosure;

FIGS. 4A and 4B show block diagrams of examples of stations (STAs) that support data fragmentation configuration management in a WLAN in accordance with various aspects of the present disclosure;

FIGS. 5-8 show flow charts illustrating examples of data fragmentation configuration management in a WLAN in accordance with various aspects of the present disclosure.

### DETAILED DESCRIPTION

According to the present disclosure, a communications device, such as a wireless station (STA), may manage a fragmentation configuration, for use in a communications session with another STA. Managing a fragmentation configuration for a communication session may include using a fragmentation configuration that supports fewer data fragments per transmission data unit than the maximum fragment capability of the STA. Additionally or alternatively, managing a fragmentation configuration may include choosing a fragmentation configuration, for a communication session, that differs from the fragmentation configuration a STA is currently using. Specifically, the STA may support more or less included data fragments in comparison to the current STA fragmentation configuration. Aspects of the disclosure are described in the context of a STA in a wireless local area network (WLAN). In general, an originator STA establishing a communications session with a recipient STA, sends a session initiation request to the recipient STA, and the recipient STA transmits a response to establish the parameters of the communications session. One or both of the recipient STA or the originator STA can manage a fragmentation configuration for the communication session by indicating or requesting use of a particular fragmentation configuration through request or response signaling.

In an example, a recipient STA receives a session initiation request from an originator STA. The recipient STA supports a first fragmentation configuration that supports inclusion of multiple data fragments per transmission data unit. The recipient STA determines to use a second fragmentation configuration in place of the first fragmentation configuration. The second fragmentation configuration supports inclusion of fewer data fragments per transmission data unit than that supported by the first fragmentation configuration. The recipient STA then transmits a session initiation response indicating use of the second fragmentation configuration.

In another example, a recipient STA receives a session initiation request from an originator STA. The recipient STA supports a first fragmentation configuration that supports inclusion of up to one data fragment per transmission data unit. The recipient STA determines to use a second fragmentation configuration in place of the first fragmentation configuration. The second fragmentation configuration supports inclusion of one data fragment per transmission data unit. The recipient STA then transmits a session initiation response indicating use of the second fragmentation configuration.

In another example, an originator STA identifies a first fragmentation configuration and a second fragmentation configuration. The first fragmentation configuration supports inclusion of multiple data fragments per transmission data unit, and the second fragmentation configuration supports inclusion of fewer data fragments per transmission data unit than that supported by the first fragmentation configuration. The originator STA transmits a session initiation request, requesting use of the second fragmentation configuration in place of the first fragmentation configuration for data transmissions. The originator STA then transmits data according to the second fragmentation configuration.

In another example, an originator STA identifies a first fragmentation configuration and a second fragmentation configuration. The first fragmentation configuration supports inclusion of up to one data fragment per transmission data unit, and the second fragmentation configuration supports inclusion of one data fragment per transmission data unit. The originator STA transmits a session initiation request requesting use of the second fragmentation configuration in place of the first fragmentation configuration for data transmissions. The originator STA then transmits data according to the second fragmentation configuration. These and other aspects of the disclosure are further illustrated by, and described with reference to, communication device diagrams, system diagrams, and flowcharts.

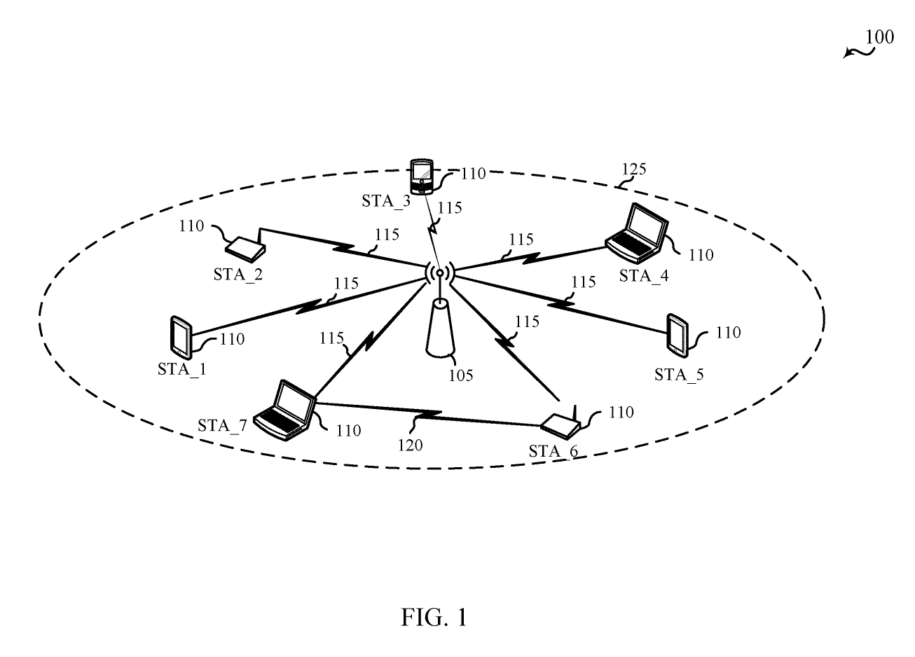

FIG. 1 illustrates an example of a network, such as a WLAN 100, that supports fragmentation configuration management in accordance with various aspects of the present disclosure. The WLAN 100 includes an access point (AP) 105 and STAs 110 labeled as STA_1 through STA_7. The STAs 110 can be mobile handsets, tablet computers, personal digital assistants (PDAs), other handheld devices, netbooks, notebook computers, tablet computers, laptops, desktop computers, display devices (e.g., TVs, computer monitors, etc.), printers, etc. While one AP 105 is illustrated, the WLAN 100 may have multiple APs 105. STAs 110, can be referred to as a mobile stations (MS), mobile devices, access terminals (ATs), user equipment (UEs), subscriber stations (SSs), or subscriber units. The STAs 110 associate and communicate with the AP 105 via a communication link 115. Each AP 105 has a coverage area 125 such that STAs 110 within that area are within range of the AP 105. The STAs 110 are dispersed throughout the coverage area 125. Each STA 110 may be stationary or mobile.

The WLAN 100 may support standardized protocols and data configurations for communication between the different entities, and between the different layers within the entities of the WLAN 100. For example, data transferred between layers (e.g., between physical (PHY) and media access control (MAC) layers) of an entity is referred to as a service data unit (SDU). Data units communicated between the MAC layer and the logical link control (LLC) layer are referred to as MAC SDUs (MSDUs), and data units communicated between the MAC and PHY layers are referred to as PHY SDUs (PSDUs). Similarly, data units referred to as protocol data units (PDUs) may be used to communicate between the same layers of peer entities (e.g., between two STAs 110). A PDU communicated between two MAC layers is referred to as a MAC PDU (MPDU) and a PDU communicated between to PHY layers is referred to as a PHY PDU (PPDU).

In some cases, the WLAN 100 supports aggregation where multiple MSDUs or MPDUs are aggregated and encapsulated into a single aggregated MSDU (A-MSDU) or aggregated MPDU (A-MPDU), respectively. Similarly, the WLAN 100 may support block acknowledgement (BA) operation, where a STA 110 aggregates several acknowledgements into a single frame. BA operation may include establishing a BA session between two STAs 110. In general, to establish a BA session, an originator STA transmits a request to a recipient STA, and the recipient STA transmits a response back to the originator STA. Communication parameters or configurations to be used for the BA session may be transmitted in one or both of the request or response messages. Data is then sent from the originator STA (e.g., MSDUs) to the recipient STA in accordance with the communication protocols established during the session initiation. Lastly, the originator STA may send a message terminating the BA session.

WLAN 100 may support data fragmentation where data is fragmented into one or more data units before transmission over the air interface. In some cases, a MSDU is divided into fragments and packaged into one or more MPDUs or A-MPDUs. Fragmentation may reduce the amount of padding needed between data transmissions, thereby increasing efficiency over the WLAN 100.

The number of MSDU fragments that can be packaged into a single MPDU or A-MPDU is controlled by a fragmentation configuration. Some STAs 110 of WLAN 100 do not support fragmentation at all, whereas other STAs 100 support single or multiple level fragmentation configurations. The different fragmentation configurations may be assigned levels to convey the fragmentation capabilities of each configuration. For example, a STA 110 that does not support fragmentation may be assigned a “level 0” fragmentation configuration. In a “level 1” fragmentation configuration, one fragment of a MSDU or management MPDU (MMPDU) is packaged into a very high throughput (VHT) single MPDU or MPDU. In a “level 2” fragmentation configuration, up to a single fragment of a MSDU or MMPDU is packaged per MPDU or A-MPDU. In a “level 3” fragmentation configuration, up to four MSDU fragments may be packaged per MPDU or A-MPDU. These fragmentation configurations are examples, and it should be understood that additional MSDU fragments may be packaged per MPDU.

A fragmentation configuration that allows for multiple fragments per MPDU (e.g., level 3), may add complexity and use additional resources compared to lower fragmentation configurations. For example, enabling a level 3 fragmentation configuration may include configuring a BA record that maintains up to 4 bits per MSDU (one bit for each fragment of the MSDU). Other complexities regarding score card maintenance and win size may result from level 3 (or any multiple-fragment) fragmentation configuration.

The fragmentation configuration capabilities (e.g., fragmentation level) of a particular STA 110 or AP 105 may be advertised or otherwise conveyed to other entities through a capabilities support frame. The fragmentation capabilities may be included in a beacon signal, or may be included in one or both of a BA response or BA request message. In some cases, a STA 110 or AP 105 may be statically configured to use a particular fragmentation configuration, such as the fragmentation configuration that supports the most MSDU fragments per MPDU (e.g., level 3). A static configuration scheme may result in a STA 110 reserving resources (e.g., BA response resources) for a higher fragmentation configuration (e.g., level 3) even if a peer STA 110 attempts to communicate (or is capable of communicating) using a lower fragmentation configuration (e.g., level 2 or level 1).

In accordance with aspects of the present disclosure, a STA 110 manages a fragmentation configuration for a communications session by deciding to use, or requesting to use, a reduced fragmentation configuration (e.g., level 2 instead of level 3, level 1 instead of level 3, or level 2 instead of level 3). In other examples, a STA 110 may decide to use, or request to use, a fragmentation configuration with more fragmentation capabilities (e.g., level 3 instead of level 2, level 3 instead of level 1, or level 2 instead of level 1).

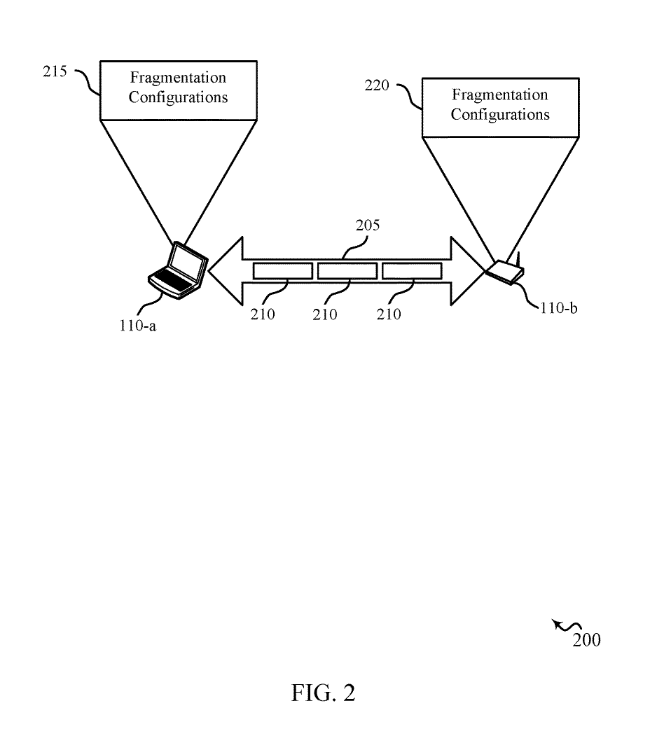

FIG. 2 illustrates one example of wireless communications subsystem 200 that supports fragmentation configuration management in a WLAN in accordance with aspects of the present disclosure. Wireless communications subsystem 200 includes STAs 110-a and 110-b, which are examples of the STA 110 of FIG. 1. In this example, STA 110-a and STA 110-b support fragmented data transmissions, where data 205 is divided into individual fragments 210 for transmission to STA 110-b. The data 205 comprises data units, such as one or more MSDUs, that are each divided into fragments 210 of equal or unequal size. As described above, one or more MSDU fragments 210 are packaged into individual MPDUs or A-MPDUs, depending on the fragmentation configurations 215, 220 stored at the respective STAs 110-a, 110-b. The STA 110-a is capable of negotiating with STA 110-b, or vice versa, to modify the fragmentation configurations 215, 220 used for a particular communications session.

In an example of a fragmentation configuration management between STA 110-a and STA 110-b, STA 110-a transmits a message to STA 110-b, requesting to initiate a communications session. STA 110-a is the originator STA, attempting to establish the session, and STA 110-b is the recipient STA. In the case of a BA session, the request message is a BA request, referred to as an add block acknowledgement (ADDBA) request. In this example, both STAs 110-a, 110-b are capable of enabling a fragmentation configuration that supports multiple data fragments 210 per data transmission units (e.g., level 3). The fragmentation configuration capabilities of the STAs 110-a, 110-b are advertised or otherwise conveyed to each other either before or after the request is received from STA 110-a. For example, the fragmentation configuration capabilities are advertised in a beacon signal or a capabilities support frame.

STA 110-b determines to use a different fragmentation configuration that supports inclusion of fewer data fragments 210 per transmission data unit than that supported by the original (e.g., level 3) fragmentation configuration. The reduced (e.g., level 2) fragmentation configuration may support inclusion of up to a single data fragment 210 per data transmission unit. The STA 110-b then transmits a session initiation response (e.g., an ADDBA response) indicating to STA 110-a that STA 110-b is using the reduced fragmentation configuration for the subsequent communications session.

In other examples of fragmentation configuration management, between STA 110-a and STA 110-b, STA 110-a may negotiate with STA 110-b to use a level 1 fragmentation configuration instead of a level 3 fragmentation configuration. In yet another example, the STA 110-a may negotiate with STA 110-b to use a level 1 fragmentation configuration instead of a level 2 fragmentation configuration. In some examples, STA 110-a and STA 110-b may negotiate to use a fragmentation configuration that supports more fragmentation capabilities than an original fragmentation configuration (e.g., using level 3 instead of level 1, using level 2 instead of level 1, or using level 3 instead of level 2).

The response from the STA 110-b can indicate use of a reduced fragmentation configuration in a number of ways. In the present example, STA 110-b responds with a BA response that indicates that STA 110-b has not allocated additional resources to enable a higher level fragmentation configuration (e.g., level 3). STA 110-a then transmits data according to the fragmentation configuration indicated in the response from STA 110-b. In this example, although STA 110-a is capable fragmenting the data 205, and STA 110-b is capable of defragmenting multiple data fragments 210 per data transmission unit, STA 110-a fragments the data 205 according to a reduced fragmentation configuration based, at least in part, on the response from STA 110-b.

In another example of a fragmentation configuration negotiation between STA 110-a and STA 110-b, STA 110-a requests use of a fragmentation configuration that is reduced in comparison to the maximum fragmentation configuration capabilities of STA 110-a. STA 110-a conveys the fragmentation configuration request by transmitting a session initiation request (e.g., an ADDBA request) to STA 110-b, attempting to establish a communication session. The session initiation request may include an indication requesting a reduced fragmentation configuration in place of the original fragmentation configuration. For example, if the session initiation request is associated with a reduced fragmentation configuration (e.g., a BA request frame) rather than a higher level fragmentation configuration (e.g., a level three fragmentation BA request frame), the recipient STA 110-b will understand that the originator STA 110-a is requesting to use a reduced fragmentation configuration. The reduced fragmentation configuration may support inclusion of fewer data fragments 210 per data transmission unit than the original fragmentation configuration. In some cases, the reduced fragmentation configuration may support inclusion of up to a single data fragment 210 per data transmission unit (e.g., level 2).

The STA 110-a then transmits data 205 according to the reduced fragmentation configuration. In some cases, upon receiving the request from the STA 110-a, STA 110-b responds with a response, acknowledging the request, and indicating use of the reduced fragmentation configuration requested by STA 110-a.

Additional details related to managing fragmentation configurations are presented below. The foregoing provides one example relating to fragmentation configuration management in WLAN, and the techniques of the present disclosure are not limited to the discussion of this example.

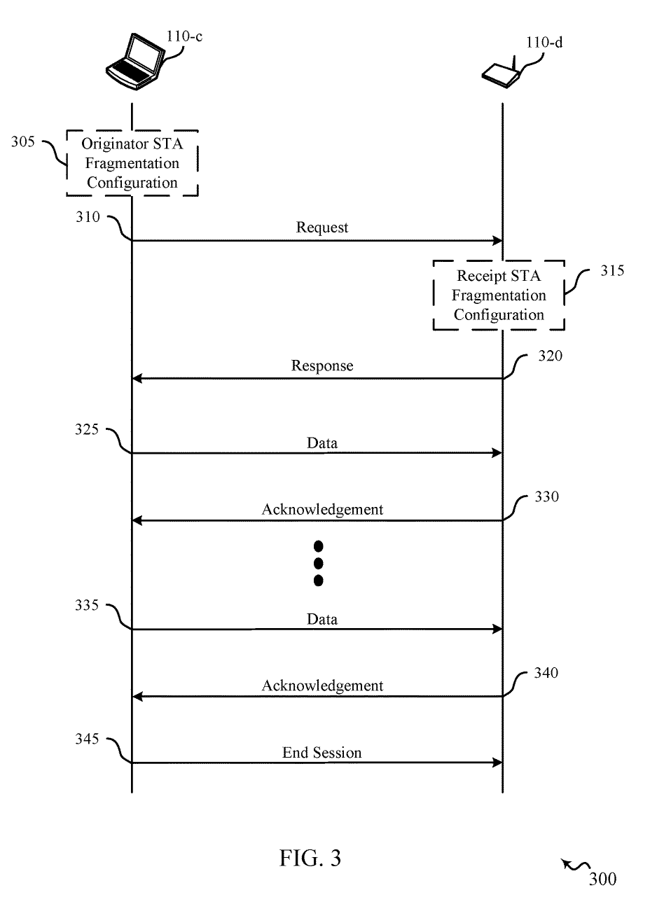

FIG. 3 shows a process flow 300 that illustrates one example of fragmentation configuration management in a WLAN in accordance with aspects of the present disclosure. Process flow 300 includes STAs 110-c and 110-d, which are examples of STAs 110, 110-a, and 110-b discussed with reference to FIGS. 1-2. One or both of STAs 110-c and 110-d are capable of using one or more request or response signals to change a fragmentation configuration used for subsequent communications. In a first example, in response to a request message from STA 110-c, STA 110-d may use a reduced fragmentation configuration and convey the reduced fragmentation configuration decision in a response message. In another example, STA 110-c requests to use a reduced fragmentation configuration and indicates this request in a session initiation request. The details of each example are provided below.

In the first example, STA 110-c is configured with a preset fragmentation configuration 305, and does not attempt to change the configuration itself. STA 110-c transmits a session initiation request 310 to STA 110-d. In the case of establishing a BA session, the request 310 is a BA request, such as an ADDBA request.

STA 110-d is configured with a fragmentation configuration 315 that supports inclusion of multiple data fragments per data transmission unit. In some cases, the data fragmentation configuration 315 supports inclusion of up to four data fragments per data transmission unit (e.g., level 3). In another example, the STA 110-d is configured with a fragmentation configuration 315 that supports inclusion of up to one data fragment per data transmission unit (e.g., level 2). However, after receiving the session initiation request 310, the STA 110-d determines to use a different fragmentation configuration 315 in place of the original configuration. In one example, the different fragmentation configuration 315 supports inclusion of fewer data fragments per transmission data unit than that supported by the original fragmentation configuration 315 (e.g., level 2 instead of level 3, or level 1 instead of level 3). In another example, the different fragmentation configuration 315 supports fewer fragmentation capabilities than the original fragmentation configuration (e.g., level 1 instead of level 2). The STA 110-d determines to use a reduced fragmentation configuration 315 even though the STA 110-c advertised its capability as supporting a higher level fragmentation configuration.

STA 110-d transmits a response 320 to the STA 110-c, indicating use of the reduced fragmentation configuration. The response 320 can indicate use of a reduced fragmentation configuration in a number of ways. In the present example, the response 320 indicates STA 110-d has not allocated additional resources for a higher level fragmentation configuration (e.g., level 3).

STA 110-c then transmits data 325 to STA 110-d in accordance with the reduced fragmentation configuration indicated in response 320. In this example, although one or both of STA 110-c and STA 110-d are capable of transmitting and receiving multiple data fragments per data transmission unit, STA 110-c transmits data 325 according to a fragmentation configuration that supports fewer fragments per data transmission unit (e.g., one fragment per data unit).

After receiving the data 325, STA 110-d responds with an acknowledgement 330. In the case of BA session, the acknowledgement 330 is a BA. The process of transmitting data 325, and receiving an acknowledgment 330, may repeat until a final data 335 is sent, and a final acknowledgement 340 is received, after which STA 110-c sends an end session message 345 to tear down the communications session (e.g., delete block acknowledgement (DELBA) message.

In another example, STA 110-c requests to use a reduced fragmentation configuration, and indicates the reduced fragmentation configuration request in the session initiation request 310. In this example, STA 110-c is capable of using a fragmentation configuration 305 that supports inclusion of multiple data fragments per data transmission unit. However, STA 110-c transmits a session initiation request 310 that includes a request to use a reduced fragmentation configuration 305 for subsequent communications. The reduced fragmentation configuration 305 may support inclusion of fewer data fragments per transmission data unit than the original fragmentation configuration 305. In another example, STA 110-c is capable of using a reduced fragmentation configuration 305 that supports inclusion of up to one data fragment per data transmission unit but requests to use a fragmentation configuration that supports only one data fragment per data transmission unit.

STA 110-d sends a response 320 to STA 110-c, indicating that STA 110-d will use a reduced fragmentation configuration instead of the original fragmentation configuration. The response 320 can indicate use of a reduced fragmentation configuration in a number of ways. In the present example, the response 320 indicates that STA 110-d has not allocated additional resources for a higher level fragmentation configuration (e.g., level 3).

Once the response 320 is received, STA 110-c sends data 325 and receives acknowledgements, as described above, until all data is sent, and an end session message 345 is transmitted. In this example, although one or both of STA 110-c and STA 110-d are capable of transmitting and receiving multiple data fragments per data transmission unit, STA 110-c transmits data 325 according to a fragmentation configuration that supports fewer fragments per data transmission unit (e.g., one fragment per data unit).

Alternative examples of the foregoing may be implemented, where some steps are performed in a different order or not at all. Some steps may additionally include additional features not mentioned above.

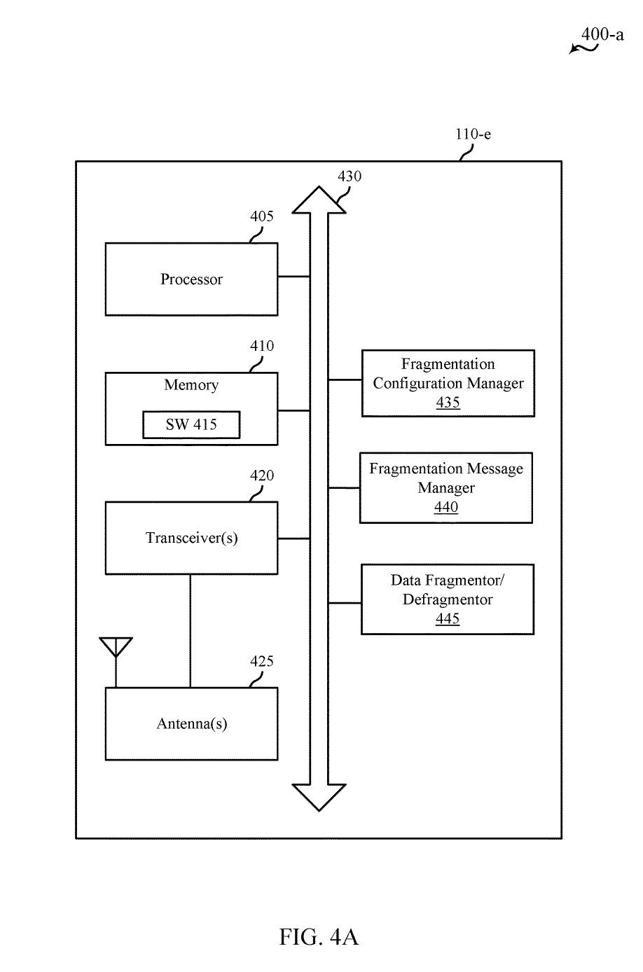

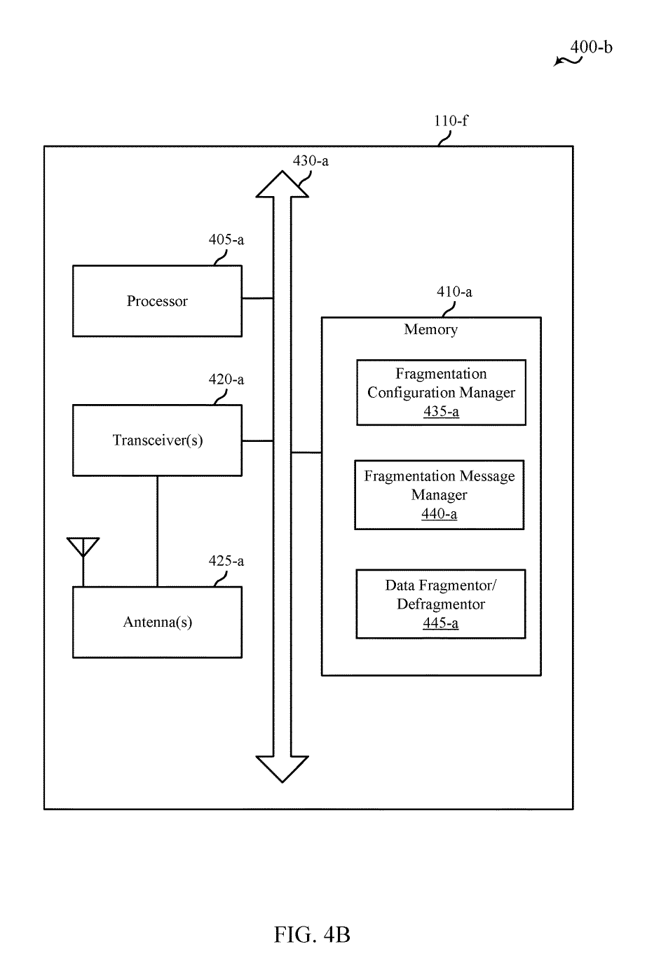

FIG. 4A shows a block diagram 400-a of an example STA 110-e that supports fragmentation configuration management in a WLAN in accordance with various aspects of the present disclosure, and with respect to FIGS. 1-3. The STA 110-e includes a processor 405, a memory 410, one or more transceivers 420, one or more antennas 425, a fragmentation configuration manager 435, a fragmentation message manager 440, and a fragmentor/defragmentor 445. The processor 405, memory 410, transceiver(s) 420, fragmentation configuration manager 435, fragmentation message manager 440, and fragmentor/defragmentor 445 are communicatively coupled with a bus 430, which enables communication between these components. The antenna(s) 425 are communicatively coupled with the transceiver(s) 420.

Processor 405 is an intelligent hardware device, such as a central processing unit (CPU), a microcontroller, an application-specific integrated circuit (ASIC), etc. Processor 405 processes information received through the transceiver(s) 420 and information to be sent to the transceiver(s) 420 for transmission through the antenna(s) 425.

Memory 410 stores computer-readable, computer-executable software (SW) code 415 containing instructions that, when executed, cause the processor 405 or another one of the components of the STA 110-e to perform various functions described herein, for example, deciding to use a reduced fragmentation configuration.

The transceiver(s) 420 communicate bi-directionally with other wireless devices, such as APs 105, STAs 110, or other devices. The transceiver(s) 420 include a modem to modulate packets and frames, and provide the modulated packets to the antenna(s) 425 for transmission. The modem is additionally used to demodulate packets received from the antenna(s) 425.

Fragmentation configuration manager 435, fragmentation message manager 440, and fragmentor/defragmentor 445 implement the features as described with reference to FIGS. 1-3, as explained below.

FIG. 4A shows one possible case of a device executing the features of FIGS. 1-3. While the components of FIG. 4A are shown as discrete hardware blocks (e.g., ASICs, field programmable gate arrays (FPGAs), semi-custom integrated circuits, etc.) for purposes of clarity, it will be understood that each of the components may be implemented by multiple hardware blocks, adapted to execute some or all of the applicable features in hardware. Alternatively, features of two or more of the components of FIG. 4A may be implemented by a single, consolidated hardware block. For example, a single transceiver 420 chip may implement the processor 405, memory 410, fragmentation configuration manager 435, fragmentation message manager 440, and fragmentor/defragmentor 445.

In other examples, the features of each component may be implemented, in whole or in part, with instructions embodied in a memory, formatted to be executed by one or more general or application-specific processors. For example, FIG. 4B shows a block diagram 400-b of another example of a STA 110-f, in which the features of the fragmentation configuration manager 435, fragmentation message manager 440, and fragmentor/defragmentor 445 are implemented as computer-readable code stored on memory 410-a, and executed by one or more processors 405-a. Other combinations of hardware/software may be used to perform the features of one or more of the components of FIGS. 4A-4B.

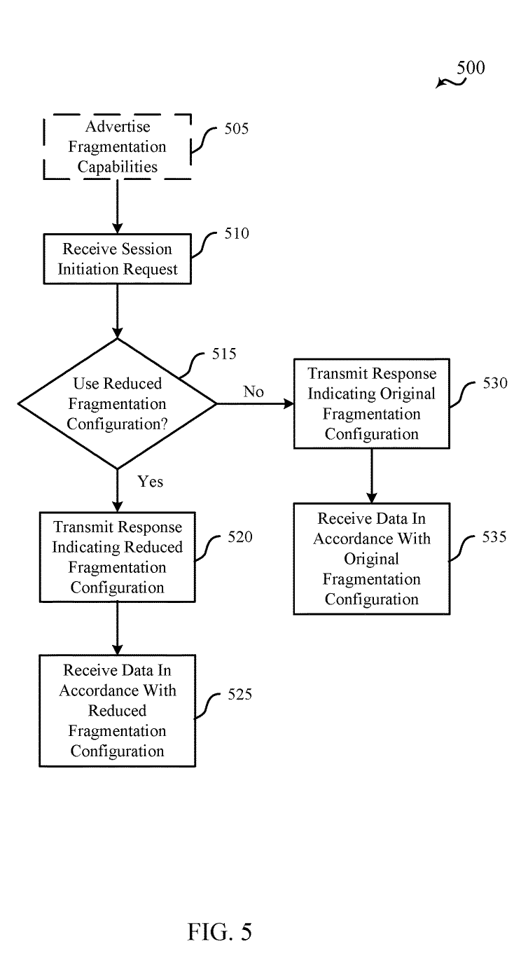

FIG. 5 shows a flow chart that illustrates an example of a method 500 for wireless communication, in accordance with aspects of the present disclosure. The method 500 may be performed by any of the STAs 110 discussed in the present disclosure, but for clarity, the method 500 will be described from the perspective of STA 110-e and STA 110-f of FIGS. 4A and 4B.

Broadly speaking, the method 500 illustrates a procedure, by which STA 110-e or STA 110-f may determine to use a reduced fragmentation configuration and conveys the reduced fragmentation configuration decision in one or both of a session initiation request or session initiation response message.

The method 500 begins with STA 110-e or STA 110-f advertising, at block 505, a fragmentation configuration capability. The fragmentation configuration capability may be advertised or otherwise conveyed in a beacon signal, or through some other configuration messaging. As indicating by the dotted lines of block 505, in some cases, STA 110-e or STA 110-f does not advertise fragmentation configuration capabilities. In this example, STA 110-e or STA 110-f is configured to use (or is capable of using) a fragmentation configuration that supports multiple data fragments per transmission data unit (e.g., level 3). In another example, STA 110-e or STA 110-f is configured to use (or is capable of using) a fragmentation configuration that supports up to one data fragment per transmission data unit (e.g., level 2).

At block 510, STA 110-e or STA 110-f receives a session initiation request from another STA 110 (e.g., an originator STA 110). As described in more detail below, in some examples the received session initiation request includes a request from an originator STA 110 to use a reduced fragmentation configuration for the communications session. In other examples, the session initiation request is a normal initiation request that corresponds to the default fragmentation configuration of the originator STA 110.

At block 515, fragmentation configuration manager 435 determines whether to use a reduced fragmentation configuration in place of the original fragmentation configuration, or to use the original fragmentation configuration. The reduced fragmentation configuration supports inclusion of fewer data fragments per transmission data unit than the original fragmentation configuration (e.g., level 1 or level 2 instead of level 3) or the reduced fragmentation configuration may support fewer fragmentation options than the original fragmentation configuration (e.g., level 1 instead of level 2). In some examples, configuration manager 435 may decide to use a reduced fragmentation configuration on its own. In other examples, the fragmentation configuration manager 435 may decide to use a reduced fragmentation configuration in response to a request from an originator STA 110 to use a reduced fragmentation configuration received at block 510.

At block 520, if the fragmentation configuration manager 435 determines to use the reduced fragmentation configuration, fragmentation message manager 440 encodes and transmits a message indicating use of the reduced fragmentation configuration. In some examples, the reduced fragmentation configuration indication message is part of a session initiation response message. Fragmentation message manager 440 may explicitly indicate use of a reduced fragmentation configuration, or may instead forgo allocating resources to enable the original fragmentation configuration, implicitly indicating use of a reduced fragmentation configuration.

At block 525, data fragmentor/defragmentor 445 receives fragmented data and defragments the fragmented data in accordance with the reduced fragmentation configuration indicated in the message at block 520.

Returning to block 515, if fragmentation configuration manager 435 determines to use the original fragmentation configuration instead of using a reduced fragmentation configuration, fragmentation message manager 440 encodes and transmits a message, at block 530, indicating use of the original fragmentation configuration. At block 535, data fragmentor/defragmentor 445 receives fragmented data and defragments the fragmented data in accordance with the original fragmentation configuration indicated in the message at block 530.

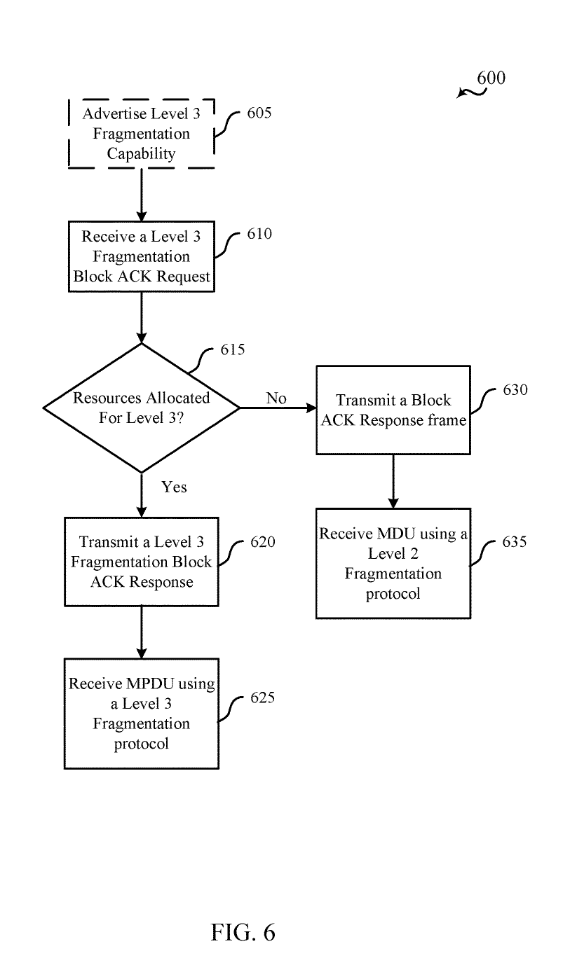

FIG. 6 shows a flow chart that illustrates an example of a method 600 for wireless communication, in accordance with aspects of the present disclosure. The method 600 may be performed by any of the STAs 110 discussed in the present disclosure, but for clarity the method 600 will be described from the perspective of STA 110-e and STA 110-f of FIGS. 4A and 4B. Method 600 may be a specific example of method 500 described for illustration purposes.

Broadly speaking, the method 600 illustrates a procedure by which STA 110-e or STA 110-f determines to use a level 2 fragmentation configuration instead of a level 3 fragmentation configuration and conveys the fragmentation configuration decision in one or both of a session initiation request or session initiation response message.

The method 600 begins with STA 110-e or STA 110-f advertising, at block 605, that STA 110-e or STA 110-f is capable of, or is configured for, a level 3 fragmentation configuration. As such, STA 110-e or STA 110-f is capable of transmitting and receiving multiple (e.g., up to 4) MSDU fragments per MPDU. The fragmentation configuration capability may be advertised or otherwise conveyed in a beacon signal or through some other configuration messaging.

At block 610, STA 110-e or STA 110-f receives a level 3 fragmentation block ACK request from another STA 110 (e.g., an originator STA 110).

At block 615, fragmentation configuration manager 435 determines whether to allocate resources to enable use of a level 3 fragmentation configuration.

At block 620, if resources were allocated for level 3 fragmentation configuration, fragmentation message manager 440 encodes and transmits a response message indicating use of level 3 fragmentation configuration. In this example, fragmentation message manager 440 transmits a level 3 fragmentation block ACK response, which may include additional resources to facilitate the additional MSDU fragments per MPDU. For example, the level 3 fragmentation block ACK response includes up to 4 bits per MSDU (one bit for each MSDU fragment).

At block 625, data fragmentor/defragmentor 445 receives one or more MPDUs or A-MPDUs using a level 3 fragmentation protocol. For example, each MPDU includes multiple MSDU fragments (e.g., up to 4 MSDU fragments).

Returning to block 615, if the resources for level 3 fragmentation were not allocated, fragmentation message manager 440 encodes and transmits a message, at block 630, indicating use of a level 2 fragmentation configuration (or a different reduced fragmentation configuration). In this example, the response message is a block ACK response frame (as opposed to a level 3 fragmentation block ACK response frame) to indicate use of a level 2 fragmentation configuration. In another example, the response message may indicate that level 3 fragmentation configuration is not supported. Upon receiving a response message other than a level 3 configuration BA response message, the originator STA 110 will use level 2 fragmentation configuration for subsequent data transmissions.

At block 635, data fragmentor/defragmentor 445 receives one or more MPDUs or A-MPDUs using a level 2 fragmentation protocol. For example, the data includes one or more MPDUs or A-MPDUs, that each include up to a single MSDU fragment.

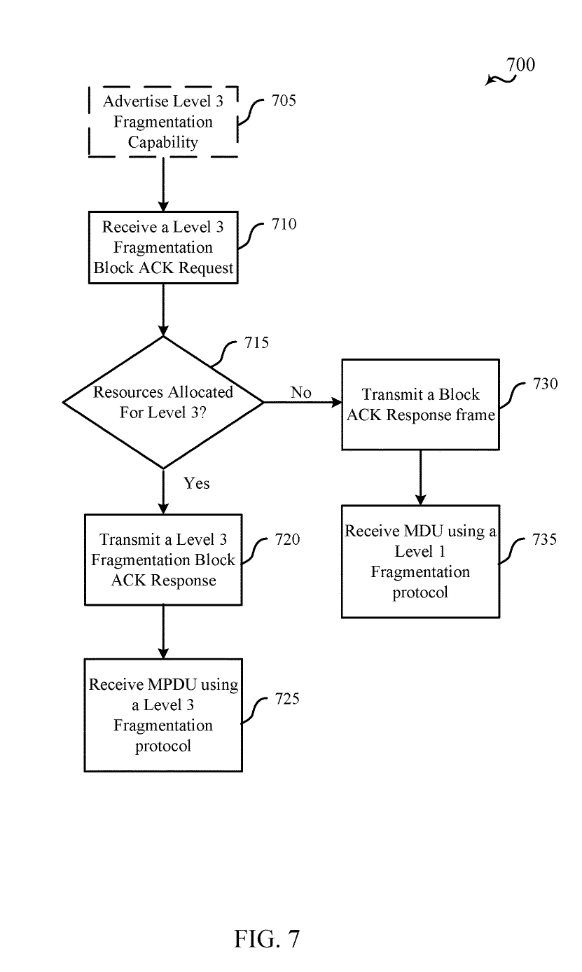

FIG. 7 shows a flow chart that illustrates an example of a method 700 for wireless communication, in accordance with aspects of the present disclosure. The method 700 may be performed by any of the STAs 110 discussed in the present disclosure, but for clarity the method 700 will be described from the perspective of STA 110-e and STA 110-f of FIGS. 4A and 4B. Method 700 may be a specific example of method 500 described for illustration purposes.

Broadly speaking, the method 700 illustrates a procedure by which STA 110-e or STA 110-f determines to use a level 1 fragmentation configuration instead of a level 3 fragmentation configuration and conveys the fragmentation configuration decision in one or both of a session initiation request or session initiation response message.

The method 700 begins with STA 110-e or STA 110-f advertising, at block 705, that STA 110-e or STA 110-f is capable of, or is configured for, a level 3 fragmentation configuration. As such, STA 110-e or STA 110-f is capable of transmitting and receiving multiple (e.g., up to 4) MSDU fragments per MPDU. The fragmentation configuration capability may be advertised or otherwise conveyed in a beacon signal or through some other configuration messaging.

At block 710, STA 110-e or STA 110-f receives a level 3 fragmentation block ACK request from another STA 110 (e.g., an originator STA 110).

At block 715, fragmentation configuration manager 435 determines whether to allocate resources to enable use of a level 3 fragmentation configuration.

At block 720, if resources were allocated for level 3 fragmentation configuration, fragmentation message manager 440 encodes and transmits a response message indicating use of level 3 fragmentation configuration. In this example, fragmentation message manager 440 transmits a level 3 fragmentation block ACK response, which may include additional resources to facilitate the additional MSDU fragments per MPDU. For example, the level 3 fragmentation block ACK response includes up to 4 bits per MSDU (one bit for each MSDU fragment).

At block 725, data fragmentor/defragmentor 445 receives one or more MPDUs or A-MPDUs using a level 3 fragmentation protocol. For example, each MPDU includes multiple MSDU fragments (e.g., up to 4 MSDU fragments).

Returning to block 715, if the resources for level 3 fragmentation were not allocated, fragmentation message manager 440 encodes and transmits a message, at block 730, indicating use of a level 1 fragmentation configuration (or a different reduced fragmentation configuration). In this example, the response message is a block ACK response frame (as opposed to a level 3 fragmentation block ACK response frame) to indicate use of a level 1 fragmentation configuration. In another example, the response message indicates that level 3 fragmentation configuration is not supported. Upon receiving a response message other than a level 3 configuration BA response message, the originator STA 110 may use level 1 fragmentation configuration for subsequent data transmissions.

At block 735, data fragmentor/defragmentor 445 receives one or more MPDUs or A-MPDUs using a level 1 fragmentation protocol. For example, the data includes one or more MPDUs or VHT single MPDUs that each include one MSDU fragment.

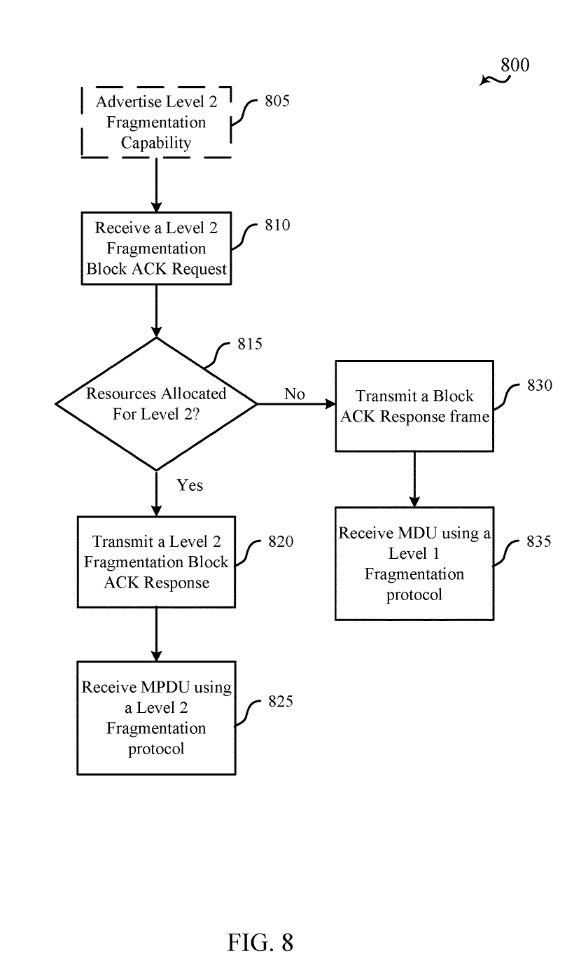

FIG. 8 shows a flow chart that illustrates an example of a method 800 for wireless communication, in accordance with aspects of the present disclosure. The method 800 may be performed by any of the STAs 110 discussed in the present disclosure, but for clarity the method 800 will be described from the perspective of STA 110-e and STA 110-f of FIGS. 4A and 4B. Method 800 may be a specific example of method 500 described for illustration purposes.

Broadly speaking, the method 800 illustrates a procedure by which the STA 110-e or STA 110-f determines to use a level 1 fragmentation configuration instead of a level 2 fragmentation configuration and conveys the fragmentation configuration decision in one or both of a session initiation request or session initiation response message.

The method 800 begins with STA 110-e or STA 110-f advertising, at block 805, that STA 110-e or STA 110-f is capable of, or is configured for, a level 2 fragmentation configuration. As such, STA 110-e or STA 110-f is capable of transmitting and receiving up to one MSDU fragments per MPDU. The fragmentation configuration capability may be advertised or otherwise conveyed in a beacon signal or through some other configuration messaging.

At block 810, STA 110-e or STA 110-f receives a level 2 fragmentation block ACK request from another STA 110 (e.g., an originator STA 110).

At block 815, fragmentation configuration manager 435 determines whether to allocate resources to enable use of a level 2 fragmentation configuration.

At block 820, if resources were allocated for level 2 fragmentation configuration, fragmentation message manager 440 encodes and transmits a response message indicating use of level 2 fragmentation configuration.

At block 825, data fragmentor/defragmentor 445 receives one or more MPDUs or A-MPDUs using a level 2 fragmentation protocol.

Returning to block 815, if the resources for level 2 fragmentation were not allocated, fragmentation message manager 440 encodes and transmits a message, at block 830, indicating use of a level 1 fragmentation configuration (or a different reduced fragmentation configuration). In this example, the response message is a block ACK response frame to indicate use of a level 1 fragmentation configuration. In another example, the response message indicates that level 2 fragmentation configuration is not supported. Upon receiving a response message other than a level 2 configuration BA response message, the originator STA 110 may use level 1 fragmentation configuration for subsequent data transmissions.

At block 835, data fragmentor/defragmentor 445 receives one or more MPDUs or A-MPDUs using a level 1 fragmentation protocol. For example, the data includes one or more MPDUs or VHT single MPDUs that each include one MSDU fragment.

As described above, a STA 110 or AP 105 uses response and request signaling in the context of a BA session to manage fragmentation configurations for the session. For example, a STA 110 attempting to communicate using level 3 fragmentation will send a level 3 fragmentation request (e.g., L3 FRAG ADDBA Request) or a level 3 fragmentation response (e.g., L3 FRAG ADDBA Response). A STA 110 attempting to communicate using level 2 communication will send a response or request other than a level 3 fragmentation response or request (e.g., ADDBA Response or ADDBA Request). Furthermore, depending on whether level 3 fragmentation configuration was enabled during a BA session, the originator STA will send a level 3 session teardown message (e.g., L3 FRAG DELBA) or a level 2 (or some other non-level 3) teardown message (e.g., DELBA). The identity or type of message can be indicated in a Block ACK Action field of a message. An example correspondence between Block ACK Action field values and the type of message is illustrated in Table 1 below.

TABLE 1
Block ACK Action field values
and corresponding labels.

| Block ACK | |
|---|---|
| Action | |
| field values | Meaning |
| 0 | ADDBA Request |
| 1 | ADDBA Response |
| 2 | DELBA |
| 3 | L3 FRAG ADDBA |
| | Request |
| 4 | L3 FRAG ADDBA |
| | Response |
| 5 | L3 FRAG DELBA |
| 6-127 | Reserved |
| . . . | . . . |

The detailed description set forth above, in connection with the appended drawings, describes examples and does not singularly represent examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. The described techniques, however, may be practiced without the specific details. In some examples, aspects from two or more of the methods set forth above may be combined. It should be noted, that the operations of the methods may be rearranged or otherwise modified such that other implementations are possible. In some instances, well-known structures and apparatuses are shown in block diagram form, in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may be implemented as a combination of computing devices, (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on, or transmitted over, as one or more instructions or code on a non-transitory computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. As used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C). As used herein, including in the claims, the term “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on” or “based, at least in part, on.”

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a non-transitory computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communication, comprising:
receiving, at a recipient station (STA), a session initiation request from an originator STA, wherein the recipient STA supports a first fragmentation configuration that supports inclusion of up to one data fragment per transmission data unit;
determining to use a second fragmentation configuration in place of the first fragmentation configuration, the second fragmentation configuration supporting inclusion of one data fragment per transmission data; and
transmitting a session initiation response indicating use of the second fragmentation configuration.

2. The method of claim 1, further comprising:
indicating in the session initiation response that the recipient STA will not use the first fragmentation configuration.

3. The method of claim 2, wherein indicating that the recipient STA will not use the first fragmentation configuration is based at least in part on the recipient STA not allocating resources to enable the first fragmentation configuration.

4. The method of claim 1, further comprising:
indicating in a capabilities field that the first fragmentation configuration is enabled at the recipient STA before receiving the session initiation request.

5. The method of claim 1, wherein:
the transmission data unit comprises a medium access control layer protocol data unit (MPDU); and
each data fragment is a fragment of a medium access control layer service data unit (MSDU).

6. The method of claim 1, wherein:
the session initiation request comprises an add block acknowledgement (ADDBA) request; and
the session initiation response comprises an ADDBA response.

7. A method for wireless communication, comprising:
identifying, at an originator station (STA), a first fragmentation configuration and a second fragmentation configuration, the first fragmentation configuration supporting inclusion of up to one data fragment per transmission data unit, and the second fragmentation configuration supporting inclusion of one data fragment per transmission data unit;
transmitting a session initiation request requesting use of the second fragmentation configuration in place of the first fragmentation configuration for data transmissions; and
transmitting data according to the second fragmentation configuration.

8. The method of claim 7, further comprising:
receiving a session initiation response from a recipient STA indicating that the recipient STA will not use the first fragmentation configuration.

9. The method of claim 8, wherein indicating that the recipient STA will not use the first fragmentation configuration is based at least in part on the recipient STA not allocating resources to enable the first fragmentation configuration.

10. The method of claim 8, wherein:
the session initiation request comprises an add block acknowledgement (ADDBA) request; and
the session initiation response comprises an ADDBA response.

11. The method of claim 7, wherein:
the transmission data unit comprises a medium access control layer protocol data unit (MPDU); and
each data fragment is a fragment of a medium access control layer service data unit (MSDU).

12. A communications device, comprising:
a receiver to receive, at a recipient station (STA), a session initiation request from an originator STA, wherein the recipient STA supports a first fragmentation configuration that supports inclusion of up to one data fragment per transmission data unit;
a fragmentation configuration manager to determine to use a second fragmentation configuration in place of the first fragmentation configuration, the second fragmentation configuration supporting inclusion of one data fragment per transmission data unit; and
a transmitter to transmit a session initiation response indicating use of the second fragmentation configuration.

13. The communications device of claim 12, further comprising:
a fragmentation message manager to indicate in the session initiation response that the recipient STA will not use the first fragmentation configuration.

14. The communications device of claim 13, wherein indicating that the recipient STA will not use the first fragmentation configuration is based at least in part on the recipient STA not allocating resources to enable the first fragmentation configuration.

15. The communications device of claim 12, further comprising:
a fragmentation message manager to indicate in a capabilities field that the first fragmentation configuration is enabled at the recipient STA before receiving the session initiation request.

16. The communications device of claim 12, wherein:
the transmission data unit comprises a medium access control layer protocol data unit (MPDU); and
each data fragment is a fragment of a medium access control layer service data unit (MSDU).

17. The communications device of claim 12, wherein:
the session initiation request comprises an add block acknowledgement (ADDBA) request; and
the session initiation response comprises an ADDBA response.

18. A communications device, comprising:
a fragmentation configuration manager to identify, at an originator station (STA), a first fragmentation configuration and a second fragmentation configuration, the first fragmentation configuration supporting inclusion of up to one data fragment per transmission data unit, and the second fragmentation configuration supporting inclusion of one data fragment per transmission data unit;
a fragmentation message manager to transmit a session initiation request requesting use of the second fragmentation configuration in place of the first fragmentation configuration for data transmissions; and
a transmitter to transmit data according to the second fragmentation configuration.

19. The communications device of claim 18, further comprising:
a receiver to receive a session initiation response from a recipient STA indicating that the recipient STA will not use the first fragmentation configuration.

20. The communications device of claim 19, wherein indicating that the recipient STA will not use the first fragmentation configuration is based at least in part on the recipient STA not allocating resources to enable the first fragmentation configuration.

21. The communications device of claim 19, wherein:
the session initiation request comprises an add block acknowledgement (ADDBA) request; and
the session initiation response comprises an ADDBA response.

22. The communications device of claim 18, wherein:
the transmission data unit comprises a medium access control layer protocol data unit (MPDU); and
each data fragment is a fragment of a medium access control layer service data unit (MSDU).
